(19) United States
(12) Patent Application Publication
(10) Pub. No.: US 2021/0403327 A1
(43) Pub. Date: Dec. 30, 2021

(54) HEATING FURNACE AND PRODUCTION METHOD FOR GRAPHITE

(71) Applicant: KANEKA CORPORATION, Osaka (JP)

(72) Inventors: Satoshi Katayama, Hyogo (JP); Toshihiko Kimura, Hyogo (JP); Naoto Iitsuka, Hyogo (JP); Takahiro Kotetsu, Osaka (JP); Masashi Taguchi, Hyogo (JP)

(73) Assignee: KANEKA CORPORATION, Osaka (JP)

(21) Appl. No.: 17/472,014

(22) Filed: Sep. 10, 2021

Related U.S. Application Data
(63) Continuation of application No. PCT/JP2020/001719, filed on Jan. 20, 2020.

(30) Foreign Application Priority Data
Mar. 12, 2019 (JP) 2019-045065

(51) Int. Cl. C01B 32/205; B01J 6/00; B01J 19/14; F27B 5/16

(52) U.S. Cl. CPC C01B 32/205; B01J 6/008; F27B 2005/161; F27B 5/16; B01J 19/14

(57) ABSTRACT

Provided are a heating furnace and a graphite production method both of which allow a carbonization step and a graphitization step to be consecutively performed. The heating furnace is a heating furnace for producing graphite from a polymeric material, and includes a heating furnace body for subjecting the polymeric material to heat treatment. The heating furnace body includes a closed vessel for containing the polymeric material. A gas outlet pipe is connected to the closed vessel, the gas outlet pipe being for letting, out of the heating furnace body, a pyrolytic gas generated from the polymeric material.

### TECHNICAL FIELD

One or more embodiments of the present invention relate to a heating furnace for producing graphite and a graphite production method.

### BACKGROUND

There are commonly known heating furnaces for firing a polymeric material such as polyimide at a temperature as high as not less than 2500° C. to produce graphite. Specifically, graphite is produced through (i) a carbonization step of carbonizing a film-like polymeric material in heat treatment (preheating) at approximately 1000° C. to obtain a carbonaceous film and (ii) a graphitization step of graphitizing (converting into graphite) a carbonaceous film, prepared in the carbonization step, by firing the carbonaceous film at a temperature as high as not less than 2500° C. According to Patent Literature 1, since heat treatment temperatures in the carbonization step and the graphitization step are different from each other, heating furnaces having different structures are used for the steps.

### PATENT LITERATURE

### Patent Literature 1

Japanese Patent Application Publication, Tokukaihei, No. 3-75211

In the above carbonization step, a flammable pyrolytic gas is generated from the polymeric material due to the heat treatment. Therefore, in a case of using the same heating furnace for the carbonization step and the graphitization step with the aim of, for example, reducing time to produce graphite or simplifying steps, the pyrolytic gas generated in the carbonization step adversely affect a heater and a heat insulator of the heating furnace during the graphitization step. Specifically, when the heater and the heat insulator are polluted with the pyrolytic gas, the following described by way of example arise in the graphitization step: a temperature inside the heating furnace does not reach a temperature as high as not less than 2500° C.; the risk of ignition is posed; and lives of the heat insulator and the heater are shortened. In other words, the inventors of one or more embodiments of the present invention have found that use of the same heating furnace for the carbonization step and the graphitization step causes the above.

### SUMMARY

An aspect of one or more embodiments of the present invention provides a heating furnace and a graphite production method both of which allow a carbonization step and a graphitization step to be consecutively performed.

The inventors of one or more embodiments of the present invention studied diligently and have eventually found that it is possible to consecutively perform a carbonization step and a graphitization step by designing a heating furnace such that the heating furnace includes a heating furnace body which includes therein a closed vessel for containing a polymeric material, and an outlet pipe is connected to the closed vessel, the outlet pipe being for letting, out of the heating furnace body, a pyrolytic gas generated from the polymeric material. Thus, the inventors completed the present invention.

The heating furnace in accordance with an aspect of one or more embodiments of the present invention is a heating furnace for producing graphite from a polymeric material, the heating furnace including a heating furnace body for subjecting the polymeric material to heat treatment, the heating furnace body including therein a closed vessel for containing the polymeric material, an outlet pipe being connected to the closed vessel, the outlet pipe being for letting, out of the heating furnace body, a pyrolytic gas generated from the polymeric material.

It is preferable that the closed vessel, which needs to be capable of withstanding the graphitization step, be made of graphite. It is preferable that an inlet pipe be connected to the closed vessel, the inlet pipe being for letting an inert gas into the closed vessel, to drive out (let out) the pyrolytic gas generated in the closed vessel.

A graphite production method in accordance with an aspect of one or more embodiments of the present invention is a method for producing graphite from a polymeric material, the method including: an introduction step of introducing, into a heating furnace body, a closed vessel containing the polymeric material; a carbonization step of carbonizing the polymeric material contained in the closed vessel, to obtain a carbonaceous film; a graphitization step of graphitizing the carbonaceous film prepared in the carbonization step, to obtain the graphite; and a takeout step of taking, out of the closed vessel, the graphite prepared in the graphitization step, at least the carbonization step including a letting-out step of letting, out of the heating furnace body, a pyrolytic gas generated from the polymeric material, the carbonization step and the graphitization step being consecutively performed.

The introduction step may include an outlet pipe attachment step, which is a step of attaching, to the closed vessel, an outlet pipe for letting, out of the heating furnace body, the pyrolytic gas generated from the polymeric material. The introduction step may include an inlet pipe attachment step, which is a step of attaching, to the closed vessel, an inlet pipe for letting an inert gas into the closed vessel. The letting-out step may include an inert gas letting-in step of letting an inert gas into the closed vessel.

With an aspect of one or more embodiments of the present invention, members inside a furnace such as a furnace wall, a heater, and a heat insulator are not polluted with a pyrolytic gas generated in a carbonization step. Thus, it is possible to provide a heating furnace which allows the carbonization step and a graphitization step to be consecutively performed, and a graphite production method. Since the heating furnace allows the carbonization step and the graphitization step to be consecutively performed, the heating furnace is excellent in convenience such as space saving and simplification of steps. Furthermore, the production method eliminates the need to take out a carbonaceous film between the carbonization step and the graphitization step, and thus eliminates the need to temporarily cool the carbonaceous film. This makes it possible to cope with production time reduction and energy saving, and thus enables graphite production at lower cost.

### BRIEF DESCRIPTION OF THE DRAWINGS

FIG. 1 is a front view schematically illustrating a configuration of a heating furnace in accordance with one or more embodiments of the present invention.

FIG. 2 is a front view illustrating a configuration of a main part of the heating furnace.

FIG. 3 is a perspective view illustrating the configuration of the main part of the heating furnace.

FIG. 4 is a front view illustrating a configuration of a main part of a heating furnace in accordance with one or more embodiments of the present invention.

### DETAILED DESCRIPTION

The following description will discuss one or more embodiments of the present invention in detail. Embodiments of the present invention are not limited to these embodiments, and can be altered in various ways by a person skilled in the art within the scope of this disclosure. Any embodiments based on a proper combination of technical means disclosed in different embodiments is also encompassed in the technical scope of one or more embodiments of the present invention. Any numerical range expressed as “A to B” in the present specification means “not less than A and not more than B”, unless otherwise specified. Further, the terms “weight” and “mass” are synonymous with each other.

### Heating Furnace

A heating furnace in accordance with one or more embodiments of the present invention is a heating furnace for producing graphite from a polymeric material, and has the following configuration: the heating furnace includes a heating furnace body for subjecting the polymeric material to heat treatment; the heating furnace body includes therein a closed vessel for containing the polymeric material; and an outlet pipe is connected to the closed vessel, the outlet pipe being for letting, out of the heating furnace body, a pyrolytic gas generated from the polymeric material.

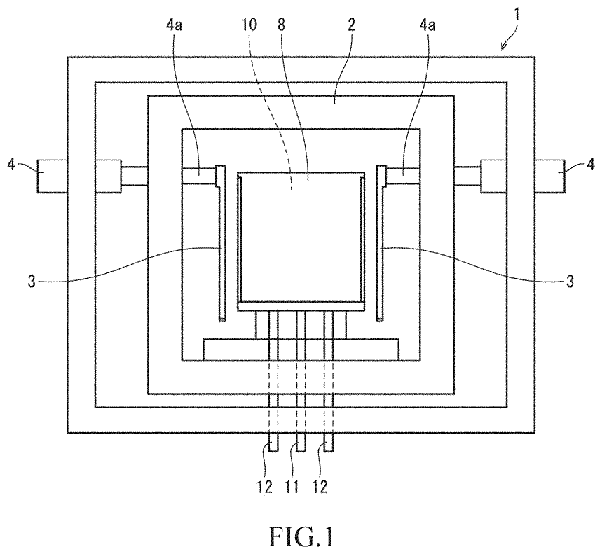

As illustrated in FIG. 1, the heating furnace includes, in a housing 1, a heating furnace body 2 formed by assembling a plurality of plate-like heat insulators in a rectangular parallelepiped shape. The heating furnace body 2 includes a pair of main heaters (heaters) 3 which is disposed inside the heating furnace body 2 so as to be in correspondence with a set of opposite side surfaces of the heating furnace body 2. In addition, the heating furnace body 2 includes a door (not illustrated), for sealing the inside of the heating furnace body 2, on one of another set of side surfaces which the main heaters 3 are not disposed in correspondence with. The heating furnace body 2 further includes therein a closed vessel 8 for containing a polymeric material 10. The closed vessel 8 is taken in through the door and housed in the heating furnace body 2.

The heating furnace further includes power feeding sections 4 for supplying electricity to the main heaters 3 inside the heating furnace body 2. The power feeding sections 4 have respective power feeding rods 4a made of graphite for directly connecting the power feeding sections 4 to the respective main heaters 3.

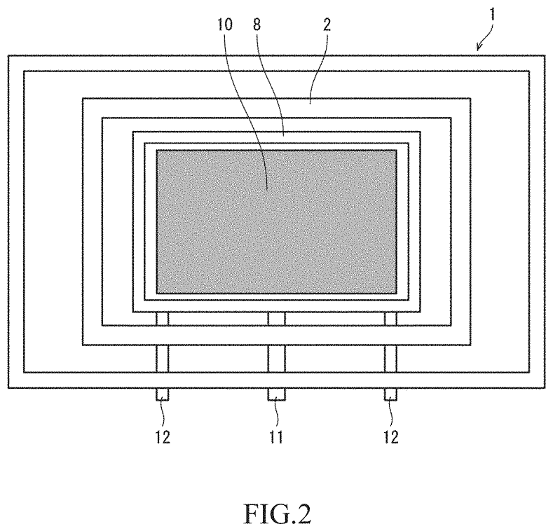

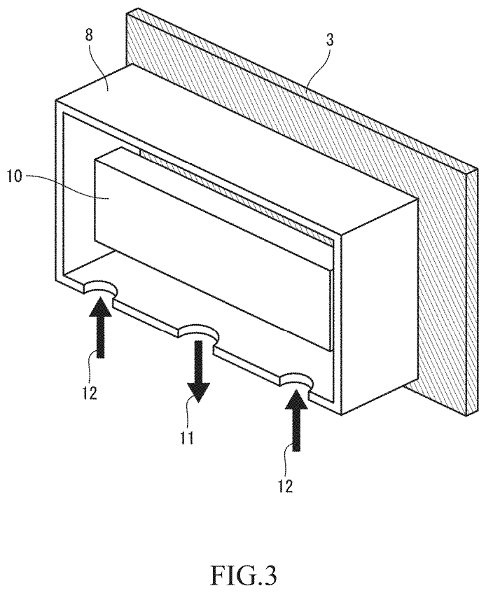

As illustrated in FIGS. 1 to 3, the heating furnace further includes a gas outlet pipe (an outlet pipe) 11 for letting, out of the heating furnace body 2, a flammable pyrolytic gas (a gas containing hydrogen, nitrogen, oxygen, and the like) generated from the polymeric material 10 inside the closed vessel 8, and optionally includes a gas inlet pipe (an inlet pipe) 12 for letting an inert gas into the closed vessel 8. Specifically, the gas outlet pipe 11 for letting, out of the heating furnace body 2, a flammable pyrolytic gas generated inside the closed vessel 8 and the optional gas inlet pipe 12 for letting an inert gas into the closed vessel 8 are connected to the closed vessel 8.

The closed vessel 8 may have a size which is somewhat smaller than that of the heating furnace body 2 so that the size allows the closed vessel 8 to contain the polymeric material 10 in an amount as large as possible. The closed vessel 8 may be made of graphite or ceramic, and may be made of graphite. The number of the closed vessels 8 to be housed in the heating furnace body 2 is not limited to a particular number.

It is preferable that the gas outlet pipe 11 and the gas inlet pipe 12 be connected to the closed vessel 8 via joints. In other words, it is preferable that, when the closed vessel 8 is taken in and housed in the heating furnace body 2, the gas outlet pipe 11 and the gas inlet pipe 12 be connected to the closed vessel 8 accordingly, and furthermore, the connection parts be sealed. The gas outlet pipe 11 and the gas inlet pipe 12 may be formed of a material having heat resistance. Calibers (internal diameters) of the gas outlet pipe 11 and the gas inlet pipe 12 may be set according to the size of the closed vessel 8 or an amount of a pyrolytic gas to be generated, and are not limited to particular calibers.

In a case where the pyrolytic gas generated from the polymeric material 10 due to heat treatment is heavier than an atmospheric gas, the connection part of the closed vessel 8 to the gas outlet pipe 11 is located at a position which is not covered by the contained polymeric material 10 and which may be in a lower part of the closed vessel 8, and may be on the bottom of the closed vessel 8. In addition, the connection part may be located at a position through which the pyrolytic gas is more efficiently let out. Although illustrated as being located at a position which is not covered by the contained polymeric material 10 and which is in the central part of the bottom of the closed vessel 8, the connection part of the gas outlet pipe 11 may be located in the peripheral part of the bottom. Further, a plurality of connection parts for the gas outlet pipe 11 may be provided. An air blower such as a blower (not illustrated) may be connected on the downstream side of the gas outlet pipe 11 so that the pyrolytic gas is let out more smoothly.

The connection part of the closed vessel 8 to the gas inlet pipe 12 is required to be located at a position which is not covered by the contained polymeric material 10 and which makes it easier, by letting in an inert gas, to let out the pyrolytic gas. The connection part may be located in the lower part of the closed vessel 8, and may be on the bottom. In addition, the connection part may be located at a position through which the pyrolytic gas is more efficiently let out. Although illustrated as being located at a position which is not covered by the contained polymeric material 10 and which is in the peripheral part of the bottom of the closed vessel 8, the connection part of the gas inlet pipe 12 may be located in the central part of the bottom. Further, a plurality of connection parts for the gas inlet pipe 12 may be provided. The connection part of the closed vessel 8 to the gas inlet pipe 12 may be located in the upper part of the closed vessel 8 so that the pyrolytic gas is more efficiently let out with use of an inert gas. A cylinder or the like which supplies an inert gas is connected on the upstream side of the gas inlet pipe 12.

Although the numbers of the gas outlet pipes 11 and the gas inlet pipes 12 may be set according to the shape or size of the closed vessel 8, and are not limited to particular numbers, the number of the gas inlet pipes 12 may be larger than that of the gas outlet pipes 11 so that letting in an inert gas from various directions makes it easier to let out the pyrolytic gas.

With the above configuration, the pyrolytic gas is let out of the heating furnace body 2 through the gas outlet pipe 11. Consequently, the heat insulators which form the heating furnace body 2 and the main heaters 3 included inside the heating furnace body 2 have little contact with the pyrolytic gas generated during the carbonization step. In other words, the heat insulators and the main heaters 3 are not polluted with the pyrolytic gas. Therefore, in a case where the same heating furnace is used to consecutively perform the carbonization step and the graphitization step, the following described by way of example do not arise in the graphitization step subsequent to the carbonization step: the temperature inside the heating furnace does not reach a temperature as high as not less than 2500° C., the risk of ignition is posed, or lives of the heater are shortened. Accordingly, it is possible to use the same heating furnace for the carbonization step and the graphitization step.

Additionally, in the case where the same heating furnace is used to consecutively perform the carbonization step and the graphitization step, there is no need to take out a carbonaceous film between the carbonization step and the graphitization step. This eliminates the need to temporarily cool the carbonaceous film, and thus makes it possible to cope with production time reduction and energy saving.

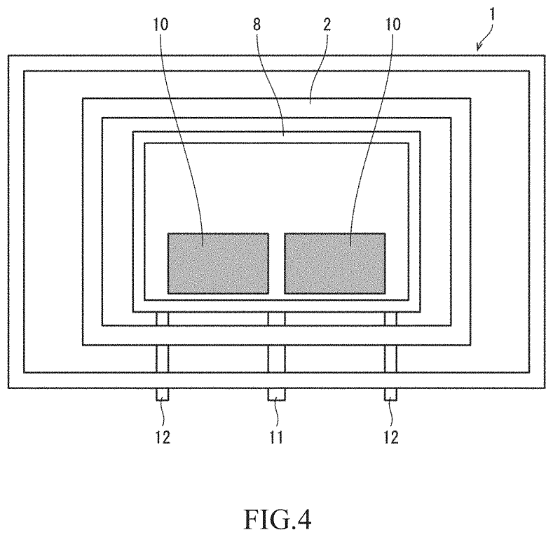

As illustrated in FIG. 4, the closed vessel 8 may house a plurality of polymeric materials 10. In this case, although illustrated as being located between the contained polymeric materials 10, the connection parts of the closed vessel 8 to the gas outlet pipe 11 and to the gas inlet pipe 12 may be located at positions which allow the pyrolytic gas and an inert gas to flow in one direction. In addition, a plurality of closed vessels may be used. Further, partitions may be provided inside the closed vessel to control the flow of the pyrolytic gas and an inert gas.

### Production Method for Graphite

Graphite, which has an excellent heat dissipation property, is used as, for example, a semiconductor element which is incorporated in various electronic devices or electrical devices such as computers, or a heat dissipation member which dissipates heat generated by the various electronic devices or electrical devices. Embodiments of the present invention include a method for producing graphite (a graphite film, a graphite sheet, and the like) using the above heating furnace.

Graphite is typically produced by the so-called polymer pyrolysis method in which a polymeric material such as polyimide is subjected to heat treatment under an inert gas atmosphere or under reduced pressure. Specifically, graphite is produced through a carbonization step of carbonizing a film-like polymeric material in heat treatment (preheating) at approximately 1000° C. to obtain a carbonaceous film, a graphitization step of graphitizing (converting into graphite) the carbonaceous film, prepared in the carbonization step, by firing the carbonaceous film at a temperature as high as not less than 2500° C., and a compression step, which is optional, of compressing the graphitized carbonaceous film (graphite).

The graphite production method in accordance with one or more embodiments of the present invention is a method for producing graphite from a polymeric material, the method including: an introduction step of introducing, into a heating furnace body, a closed vessel containing the polymeric material; a carbonization step of carbonizing the polymeric material contained in the closed vessel, to obtain a carbonaceous film; a graphitization step of graphitizing the carbonaceous film prepared in the carbonization step, to obtain graphite; and a takeout step of taking, out of the closed vessel, the graphite prepared in the graphitization step, at least the carbonization step including a letting-out step of letting, out of the heating furnace body, a pyrolytic gas generated from the polymeric material, the carbonization step and the graphitization step being consecutively performed. In other words, according to the graphite production method in accordance with one or more embodiments of the present invention, the letting-out step of letting, out of the heating furnace body, the pyrolytic gas generated from the polymeric material is performed in the carbonization step, and the carbonization step and the graphitization step are consecutively performed (without taking the polymeric material out of the heating furnace). Further, although the polymeric material may have a film form, the form of the polymeric material is not limited to a particular form. Note that the following description will discuss an example in which the polymeric material has a film form.

### Polymeric Material

Examples of the film-like polymeric material which are suitable for the graphite production include, for example, polyimide, polyamide, polyoxadiazole, polybenzothiazole, polybenzobisthiazole, polybenzoxazole, polybenzobisoxasole, polyparaphenylene vinylene, polybenzimidazole, polybenzobisimidazole, and polythiazole. In particular, polyimide is more preferable since polyimide makes it possible to produce graphite having an excellent heat diffusivity, thermal conductivity, and electrical conductivity. The polymeric material may be selected as appropriate depending on physical properties required of graphite to be produced.

### Introduction Step

The introduction step is a step of introducing, into the heating furnace body, a closed vessel containing a polymeric material in a film form (a cut sheet), or in a roll form (long length) (hereinafter, referred to as “polymeric material film”). The form of the polymeric material film to be contained in the closed vessel is not limited to a particular form. Furthermore, the number of the polymeric material films in a roll form to be contained in the closed vessel is not limited to a particular number.

In the introduction step, both an outlet pipe attachment step and an inlet pipe attachment step are also performed. The outlet pipe attachment step is a step of attaching, to the closed vessel, a gas outlet pipe for letting, out of the heating furnace body, the pyrolytic gas generated from the polymeric material. The inlet pipe attachment step is a step of attaching, to the closed vessel, a gas inlet pipe for letting an inert gas into the closed vessel.

### Carbonization Step

The carbonization step is a step of carbonizing the polymeric material film in heat treatment at approximately 1000° C., to obtain a carbonaceous film. The maximum temperature in the heat treatment may be, for example, 500° C. to 1800° C., 700° C. to 1600° C., 900° C. to 1400° C., or 1000° C.

A temperature increase rate in the carbonization step may be, for example, 0.01° C./min to 50° C./min, 0.1° C./min to 25° C./min, 0.2° C./min to 10° C./min, or 0.5° C./min to 5.0° C./min.

In carbonization step, the polymeric material film is carbonized while being contained the closed vessel. The flammable pyrolytic gas generated from the polymeric material film due to the heat treatment is let out of the heating furnace body through the gas outlet pipe. In other words, according one or more embodiments of the present invention, a letting-out step is performed at least in the carbonization step, to let, out of the heating furnace body, the flammable pyrolytic gas generated from the polymeric material film.

In addition, when the pyrolytic gas is let out of the heating furnace body through the gas outlet pipe, the pyrolytic gas may be more easily let out by letting an inert gas into the closed vessel through the gas inlet pipe. In other words, according to one or more embodiments of the present invention, an inert gas letting-in step may be performed in the letting-out step, to let an inert gas into the closed vessel.

A retention time in the carbonization step, specifically a retention time of the maximum temperature, may be not more than two hours, five minutes to one hour, or 8 minutes to 30 minutes. Note that the carbonization step is ended at a point when the pyrolytic gas is substantially no longer let out, and the graphitization step is consecutively performed.

### Graphitization Step

The graphitization step is a step of graphitizing (converting into graphite) the carbonaceous film, prepared in the carbonization step, by firing the carbonaceous film at a temperature as high as not less than 2500° C. The maximum temperature in the firing may be not less than 2500° C., not less than 2600° C., not less than 2700° C., not less than 2800° C., not less than 2900° C., not less than 3000° C., not less than 3100° C., or not less than 3200° C. The graphitization step is performed under an atmosphere of an inert gas, such as nitrogen, helium, and argon, or under reduced pressure.

A temperature increase rate in the graphitization step may be, for example, 0.01° C./min to 50° C./min, 0.1° C./min to 20° C./min, or 0.3° C./min to 10° C./min.

A retention time in the graphitization step, specifically a retention time of the maximum temperature, may be not more than two hours, five minutes to one hour, or 8 minutes to 30 minutes.

In the graphitization step, the carbonaceous film is graphitized while being contained in the closed vessel. In a case where a gas resulting from vaporization of an inorganic substance included in the polymeric material film, sublimating graphite from the closed vessel, and the like are generated, these gases may be let out through the gas outlet pipe. When the gases are let out, an inert gas may be let into the closed vessel through the gas inlet pipe so that the gases are more easily let out.

### Takeout Step

The takeout step is a step of taking, out of the heating furnace body, the closed vessel and also taking, out of the closed vessel, the graphite prepared in the graphitization step. According to one or more embodiments of the present invention, the carbonization step and the graphitization step are consecutively performed. This eliminates the need to take out the carbonaceous film between the carbonization step and the graphitization step, and makes it possible to simply perform the takeout step of taking out the graphite prepared in the graphitization step. This eliminates the need to temporarily cool the carbonaceous film, and makes it possible to cope with production time reduction and energy saving.

### Compression Step

The compression step, which is optionally performed, is a step of compressing the graphite prepared in the graphitization step. Performing the compression step makes it possible to impart plasticity to the obtained graphite. In the compression step, it is possible to compress the graphite prepared in the graphitization step by, for example, compressing, in a planar manner, the graphite with use of a press or the like, or rolling the graphite with use of a metal roller or the like. A pressing force in the compression step is not limited to a particular magnitude. Further, although the compression step is performed at a temperature of a room, the temperature is not limited to particular degrees.

The above method eliminates the need to take out the carbonaceous film between the carbonization step and the graphitization step, and thus eliminates the need to temporarily cool the carbonaceous film. This makes it possible to cope with production time reduction and energy saving, and thus enables graphite production at lower cost.

One or more embodiments of the present invention can be suitably used to produce graphite.

### REFERENCE SIGNS LIST

1 housing
2 heating furnace body
3 main heater (heater)
4 power feeding section
4a power feeding rod
8 closed vessel
10 polymeric material
11 gas outlet pipe (outlet pipe)
12 gas inlet pipe (inlet pipe)

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A heating furnace for producing graphite from a polymeric material,
the heating furnace comprising a heating furnace body for subjecting the polymeric material to heat treatment, the heating furnace body including therein a closed vessel for containing the polymeric material,
an outlet pipe being connected to the closed vessel, the outlet pipe being for letting, out of the heating furnace body, a pyrolytic gas generated from the polymeric material.

2. The heating furnace according to claim 1, wherein the closed vessel is made of graphite.

3. The heating furnace according to claim 1, wherein an inlet pipe is connected to the closed vessel, the inlet pipe being for letting an inert gas into the closed vessel.

4. A method for producing graphite from a polymeric material, the method comprising:
an introduction step of introducing, into a heating furnace body, a closed vessel containing the polymeric material;
a carbonization step of carbonizing the polymeric material contained in the closed vessel, to obtain a carbonaceous film;
a graphitization step of graphitizing the carbonaceous film prepared in the carbonization step, to obtain the graphite; and
a takeout step of taking, out of the closed vessel, the graphite prepared in the graphitization step,
at least the carbonization step including a letting-out step of letting, out of the heating furnace body, a pyrolytic gas generated from the polymeric material,
the carbonization step and the graphitization step being consecutively performed.

5. The method for producing the graphite according to claim 4, wherein the introduction step includes an outlet pipe attachment step of attaching, to the closed vessel, an outlet pipe for letting, out of the heating furnace body, the pyrolytic gas generated from the polymeric material.

6. The method for producing the graphite according to claim 4, wherein the introduction step includes an inlet pipe attachment step of attaching, to the closed vessel, an inlet pipe for letting an inert gas into the closed vessel.

7. The method for producing the graphite according to claim 6, wherein the letting-out step includes an inert gas letting-in step of letting the inert gas into the closed vessel.

8. The heating furnace according to claim 2, wherein an inlet pipe is connected to the closed vessel, the inlet pipe being for letting an inert gas into the closed vessel.

9. The method for producing the graphite according to claim 5, wherein the introduction step includes an inlet pipe attachment step of attaching, to the closed vessel, an inlet pipe for letting an inert gas into the closed vessel.
